(19) United States
(12) Patent Application Publication
(10) Pub. No.: US 2011/0045801 A1
(43) Pub. Date: Feb. 24, 2011

(54) SYSTEM, METHOD AND PROGRAM PRODUCT FOR LOCATION BASED SERVICES, ASSET MANAGEMENT AND TRACKING

(76) Inventor: Lansing Arthur Parker, II, Los Angeles, CA (US)

Correspondence Address: Lansing Arthur Parker II, 1632 N Laurel Ave #239, Los Angeles, CA, 90046, US

(21) Appl. No.: 12/914,920

(22) Filed: Oct. 28, 2010

Related U.S. Application Data
(63) Continuation-in-part of application No. 12/362,697, filed on Jan. 30, 2009.
(60) Provisional application No. 61/117,933, filed on Nov. 25, 2008.

(51) Int. Cl. H04W 4/02; H04W 12/00

(52) U.S. Cl. 455/411; 455/456.3

(57) ABSTRACT

A system, method and computer program product for a mobile communication device includes a software module configured for executing in a background mode in a processor of the mobile communication device. The software module is operable to communicate a geographical location of the mobile communication device at a scheduled time and to receive at least one command to execute an operation of the mobile communication device. A datacenter is operable to receive the geographical location and to transmit the at least one command. A secure website is in communication with the datacenter where a user can request a display of the geographical location and select the at least one command to be transmitted.

### CROSS-REFERENCE TO RELATED APPLICATIONS

The present continuation-in-part patent application claims priority benefit of the U.S. non-provisional patent application Ser. No. 12/362,697 filed on filed on 30 Jan. 2009 under 35 U.S.C. 111(a), which claimed the benefit of the filing date of the U.S. provisional application for patent Ser. No. 61/117,933 filed on Nov. 25, 2008 under 35 U.S.C. 119(e). The contents of this related patent application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to mobile applications. More particularly, the invention relates to location-based services for mobile devices.

### BACKGROUND OF THE INVENTION

There are currently 3.3 billion cell phones in the world, and the growth in cell phone ownership is not stopping. Portio Research predicts that 50% of the world's population will be using a cell phone by the end of 2009. Furthermore, cell phones are becoming more sophisticated with many different types of applications including, but not limited to, location-based services (LBS). A location-based service is an information or entertainment service accessible with mobile devices through a mobile network utilizing the ability to make use of the geographical position of the mobile device. The geographical positions of these mobile devices are typically determined for location-based services using global positioning systems (GPS) and cell phone tower triangulation, and in the U.S., every cell phone produced after 2006 is required to be GPS enabled. Location-based services are a huge market and many companies are looking at how they can provide these services. Various types of location-based services may be useful or appealing to cell phone users or service providers.

One such location-based service is a phone locator service. Losing a cell phone is a costly annoyance. Currently people are reliant on their phones more than ever, and cell phones often hold a large amount of information that can be sensitive, important and private to its owner. Furthermore, the cost of some of these devices has risen to $500-600. Approximately 20% of mobile subscribers in the U.S. have insurance on their cell phone that costs about $5 a month. When an insured subscriber loses a phone, they typically have to pay a $50 deductible. One of the top insurers in Los Angeles County replaces 400,000 lost or stolen phones a month. There is a tremendous need to help consumers locate lost and stolen cell phones to avoid paying for replacement phones. A currently known solution for finding stolen cell phones sends a text message or email with the number of the thief if the thief switches the Subscriber Identity Module (SIM) card in the stolen phone. However, this solution does nothing if the SIM card is not changed. Other known solutions use GPS to track the location of cell phones. However, these solutions operate to track the location of the phone via activated location software. For inactive location software, the location information for the mobile device may not be determined. This would enable a thief to turn off the software so that the phone could not be located. It would be highly desirable to have a novel method that could still locate the phone without the thief being aware of it. There are also several companies that currently provide ‘over the air’ contact backups automatically from a cell phone. However, these backups offer nothing to recover the phone if lost or stolen.

Another location based service that may be useful to cell phone users is a friends and family locator that enables a user to view the locations of friends and family members who also have the application on their cell phones. A currently known friends and family locator is provided by Loopt mobile. However, this method requires the application to be opened on the phone and transmit the recent location of the phone every 15 minutes to 2 hours. Furthermore, if the application is turned off completely, the current location information for the phone is removed from the system, location updating is suspended and the current location is no longer available to others using the application. Also, if the application is not used for a predetermined period of time by actually bringing the application to the foreground, location updating times out and the location information for the phone expires. Verizon also has a location product called ‘Chaperone’; however, this product requires the user to purchase a specific handset for this service, and this service is available on a very limited number of handsets. Also, this product is geared mainly toward child protection.

In view of the foregoing, there is a need for improved techniques for providing location-based services for cell phones and other mobile devices that do not require an application to be running in the foreground in order to function and frequently update the location of the cell phones.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates the architecture of an exemplary system for providing location-based services to mobile devices, in accordance with an embodiment of the present invention;

FIG. 2 is a flow chart illustrating an exemplary process for signing up for a location-based service provider, in accordance with an embodiment of the present invention;

FIG. 3 illustrates an exemplary location-based mobile device locator system, in accordance with an embodiment of the present invention;

FIG. 4 illustrates a typical computer system that, when appropriately configured or designed, can serve as a computer system in which the invention may be embodied; and

FIGS. 5A-D present a flow chart illustrating an exemplary method for interaction with the elements of location-based mobile device locator system as presented in FIG. 3, in accordance with an exemplary embodiment of the present invention.

Unless otherwise indicated illustrations in the figures are not necessarily drawn to scale.

### SUMMARY OF THE INVENTION

To achieve the forgoing and other objects and in accordance with the purpose of the invention, a system, method and computer program product for a mobile communication device is presented.

In one embodiment a system for a mobile communication device includes a software module configured for executing in a background mode in a processor of the mobile communication device. The software module is operable to communicate a geographical location of the mobile communication device at a scheduled time and to receive at least one command to execute an operation of the mobile communication device. A datacenter is operable to receive the geographical location and to transmit the at least one command. A secure website is in communication with the datacenter where a user can request a display of the geographical location and select the at least one command to be transmitted. In another embodiment the user can further select a time to transmit the at least one command. In yet another embodiment time selections for transmitting the at least one command comprises immediate and the scheduled time. In still another embodiment command selections include a ring command where execution of the ring command sets the mobile communication device to ring at an audible level and the mobile communication device is operated to ring. In another embodiment command selections include a message command where execution of the message command displays a text message on the mobile communication device. In yet another embodiment selecting the message command further transmits a message to at least one additional mobile communication device. In still another embodiment command selections include a backup command where execution of the backup command communicates stored information from the mobile communication device to the datacenter. In another embodiment command selections include a restore command where execution of the restore command retrieves stored information from the datacenter. In yet another embodiment command selections include a delete command where execution of the delete command deletes stored information from the mobile communication device. In still another embodiment command selections include a lock command where execution of the lock command prevents use of the mobile communication device.

In another embodiment a method includes connecting to a datacenter using a secure website. Sending a request to the datacenter for a geographical location of a mobile communication device. Receiving from the datacenter a last known location of the mobile communication device where the datacenter communicates with a software module configured for executing in a background mode in a processor of the mobile communication device. The software module being operable to communicate the geographical location at a scheduled time and to receive at least one command to execute an operation of the mobile communication device. Selecting the at least one command. Sending the selected at least one command to the datacenter for transmission to the software module. Selecting a time for the transmission to the software module where time selections comprise immediate and the scheduled time. Sending the selected time to the datacenter where the selected at least one command is transmitted to the software module at the selected time for execution. In another embodiment command selections include a ring command where execution of the ring command sets the mobile communication device to ring at an audible level and the mobile communication device is operated to ring. In yet another embodiment command selections include a message command where execution of the message command displays a text message on the mobile communication device. In still another embodiment selecting the message command further transmits a message to at least one additional mobile communication device. In another embodiment command selections include a backup command where execution of the backup command communicates stored information from the mobile communication device to the datacenter. In yet another embodiment command selections include a restore command where execution of the restore command retrieves stored information from the datacenter. In still another embodiment command selections include a delete command where execution of the delete command deletes stored information from the mobile communication device. In another embodiment command selections include a lock command where execution of the lock command prevents use of the mobile communication device.

In another embodiment a computer program product residing on or being distributed across one or more computer readable mediums having a plurality of instructions stored thereon which, when executed by one or more associated processors, cause the one or more processors to connect to a datacenter using a secure website. One or more associated processors send a request to the datacenter for a geographical location of a mobile communication device. One or more associated processors receive from the datacenter a last known location of the mobile communication device where the datacenter communicates with a software module configured for processing in a background mode in a processor of the mobile communication device. The software module is operable to communicate the geographical location at a scheduled time and to receive at least one command to execute an operation of the mobile communication device. One or more associated processors select the at least one command. One or more associated processors send the selected at least one command to the datacenter for transmission to the software module. One or more associated processors select a time for the transmission to the software module where time selections comprise immediate and the scheduled time. One or more associated processors send the selected time to the datacenter where the selected at least one command is transmitted to the software module at the selected time for execution. In another embodiment command selections include ring command, message command, backup command, restore command, delete command, and lock command.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

The present invention will now be described in detail with reference to embodiments thereof as illustrated in the accompanying drawings.

Embodiments of the present invention provide means and methods for providing location-based and control services as mobile applications on cell phones and other mobile devices. The software for embodiments may be coded for known mobile phone operating systems including, but not limited to, Symbian, Windows Mobil, Brew, iPhone, Android, and Blackberry. For embodiments of the present invention, the location information for the mobile devices associated with the system may be maintained in a central secure database unique to the system. The location data in this database may then be used to provide location-based and control services such as, but not limited to, locating lost or stolen cell phones, locating friends or family members, location-based social networking and dating, providing location specific advertising, current location, last known location, remote control of mobile device operation, etc. Embodiments of the present invention may also enable companies or any individual to provide their own location-based and control services. In some embodiments, the solution (i.e., the software and hardware) may be architected to accommodate 500,000 users; however, alternate embodiments may be scaled to millions of users effectively.

Various types of location-based services that may be provided by embodiments of the present invention. For example, without limitation, one type of location-based service may be described as proximity-based notification. Proximity-based notifications may include, without limitation, location-based targeted advertising, mobile location-based social networking, mobile location-based dating, etc. A non-limiting example of location-based targeted advertising may be described as when a user of a location-based service walks near a store, the user gets a message to receive 20% off a purchase at that store. In a non-limiting example of mobile location-based social networking, the system may integrate with Internet applications Linked-In, Myspace and/or Facebook to notify users when they may be in close proximity to friends, acquaintances, contacts and associates. Mobile location-based dating may integrate with various Internet dating services such as, but not limited to, Match.com, etc. Another type of location-based service may be described as proximity-based actuation. Proximity-based actuations may include, without limitation, payment based upon proximity, for example, without limitation, a toll or any other payment, automatic airport check-in, activating a smart house when in close proximity. Another type of location-based service may be described as finding someone or something for example, without limitation, a person by skill (i.e., a doctor), a business, weather, emergency 911, a taxi, food delivery, etc. Parents may also use this type of location-based service to determine the location of their children or to determine if their children may be in the proximity of a felon or child molester. Another type of location-based service may be described as resource tracking. For example, without limitation, a business owner may track his resources such as, but not limited to, taxis, service people, rental equipment, fleet management and scheduling. Another type of location-based service may be described as an alert such as, but not limited to, an alert of traffic accidents, an alert of a hurricane or tornado warning area or an area of a predicted earthquake, recent crime reports in a particular neighborhood, etc. Alerts may also provide information to users. In a non-limiting example, a user may be located in close proximity to a house recently sold or for sale and be notified of purchase price or listing price or the previous selling price of the house or of houses in close proximity. Another type of location-based service may be described as a location-based chat. In a non-limiting example of a location-based chat, a user in a commercial establishment and may receive assistance via a chat session on a mobile device while shopping, with the chat session terminating when the user exits the premises of the commercial establishment.

Location-based and control services is a huge market and the approaches provided by embodiments of the present invention offer companies an easy way to provide location-based services to their customers. Furthermore, location-based and control service providers may operate to generate revenue from location-based text message advertisements to users and advertisements on the websites associated with the location-based services. The use of location-based services according to embodiments of the present invention may operate to enable companies to provide more timely text messages and location-based marketing services with much more relevance to the user.

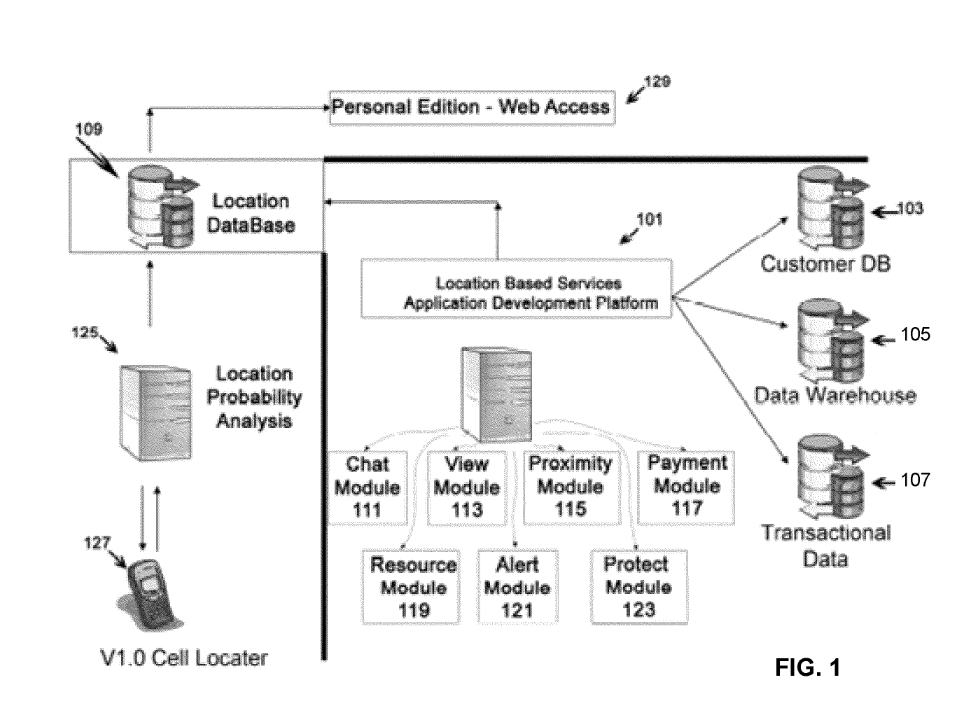

FIG. 1 illustrates the architecture of an exemplary system for providing location-based and control services to mobile devices, in accordance with an embodiment of the present invention. In the present embodiment, a location-based services application development software platform 101 of the system may be installed on a server of an entity such as, but not limited to, a company or a government agency. Once installed, location-based services application development software platform 101 may operate to integrate with back end data of the entity where the software may be installed including, but not limited to, a customer database 103, a data warehouse 105 and a transactional data database 107. This system architecture integrates the internal data and customer information of the entity with location data from location-based services application development software platform 101, bridging the gap between the detailed customer data maintained by the entity and location information for customers. This integration enables the system to have a much deeper understanding and viewpoint of the kinds of location-based services which may be provided to customers and for providing richer and meaningful alerts and communications to the individuals based upon location. For instance, without limitation, providing better marketing based upon previous purchases of customers or providing weather data for notifying those who may be entering a tornado warning area, etc.

Location-based services application development software platform 101 collects, maintains and processes geographical location information associated with users in a private central location database 109. Software residing on a user's cell phone or other type of mobile device may operate to transmit its location information using GPS or cell phone tower triangulation to location-based services application development software platform 101 at a configurable interval, for example, without limitation, every 5-30 seconds, every minute or every five minutes. The transmitted geographical information includes the geographical location of the user's cell phone or other mobile device. In the present embodiment, private central location database 109 may be located in close proximity to the system records of the entity in ownership of private central location database 109. For some applications the service provider may operate to maintain ownership of the location data and offer consumers access or use thereof by way of the software platform developed by the provider and installed by the consumer. However, an alternate embodiment comprises an alternative architecture where entities using enterprise location-based services application development software platform 101 may operate to have its own location database on its own site for storing the location information of people that have downloaded the mobile application software. In yet another embodiment, private central location database 109 may be owned by the administrator of location-based services application development software platform 101, giving them use of, not ownership of, the data of where the customers may be located in virtual real time. In other embodiments, the system may employ Enterprise Application and Data Integration and Data Quality applications currently available in the market from companies such as, but not limited to, Information Builders, Informatica, Tibco, and Teradata.

In the present embodiment, location-based services application development software platform 101 may operate to send messages to users via their mobile devices, and users may configure LBS preferences on their mobile devices to receive messages from particular location based modules. These preferences may include, without limitation, how often they would prefer to be alerted and what type of information to be alerted with such as, but not limited to, cars, houses, CD's from music stores, etc. Location-based services application development software platform 101 may operate to search private central location database 109 for users who may be located in certain areas based upon the location data received and the particular module used to perform location-based services.

In the present embodiment, location-based services application development software platform 101 comprises the following modules a chat module 111, a proximity module 113, a view module 115, a payment module 117, a resource module 119, an alert module 121, and a protect module 123. Those skilled in the art, in light of the present teachings, will readily recognize that various different modules may be included in alternate embodiments including, but not limited to, Mobile Customer Relationship Management, emergency services, smart house activation, etc. (the idea that many different modules can be developed for the enterprise software utilizing the location data and customer information for providing a multitude of location based services). Chat module 111 may operate to enable users to open a dialogue with any other user based upon geographical location. Chat module 111 may be used to provide services such as, but not limited to, a location-based customer service chat, a service enabling users to talk to friends, a service connecting sellers and buyers in particular locations, etc. Proximity module 113 may operate to provide information to users based upon the geographical location of the users. Services that may be provided by proximity module 113 include, without limitation, location-based advertising, automatic airport check in, smart house activation, crime report retrieval for an area, home price retrieval, taxi requests, etc. View module 115 may operate to enable users to view the geographical location of other users. In some embodiments, the view module 115 may operate to provide users with a view of fixed locations, as for example, without limitation, businesses or landmarks. Services that may be provided by view module 115 include, without limitation, a service for finding friends, a mobile dating service and a social or business networking service. Payment module 117 may operate to enable users to pay for anything related to use of a mobile device. Resource module 119 may operate to enable users to track resources such as, but not limited to assets, employees, children, fleet vehicles, rental cars, etc. Alert module 121 may operate to provide information and alerts based upon geographic location such as, but not limited to, traffic accidents, weather warnings, earthquake warnings, children in close proximity to a criminal, etc. Protect module 123 may operate to prevent credit card or financial fraud by matching the geographic location of a user with the location of a purchase or other activity involving the user's credit card or bank account. For example, if the location of the user as indicated in private central location database 109 is not the same location as for the location of the purchase or account activity, there may be a higher probability for fraud, enabling a financial institution to prevent potentially fraudulent transactions. Furthermore, companies installing location-based services application development software platform 101 may operate to generate their own LBS applications for their customers such as, but not limited to, providing information, marketing, alerts, service, and entertainment. In these various embodiments, the system may operate to, through real time data integration, data quality, and business to business integration, create a customer record in real time from user activities associated with the participating entities. The system may then operate to perform statistical analysis for the probability that a user may respond favorably to, without limitation, certain messages, information, alerts, location-based marketing, etc.

In an effort to optimize response rates, enhance the end user experience and dramatically reduce unwanted messages, a location probability analysis (LPA) server 125 may operate to perform probability analysis algorithms and artificial intelligence in order to generate and transmit timely marketing messages to high probability of success persons based upon their location, time and date. After processing the location probability information, LPA server 125 may operate to store information in private central location database 109. In a non-limiting example, LPA server 125, where appropriate, may operate to predict if the likelihood of an end user responding to a location based marketing message for example. For some situations, the predictions performed by LPA server 125 may not be needed for the system alerting the end user of entering into a geographical location in close proximity to such as, but not limited to, a tornado area, earthquake area, etc.

The present embodiment comprises a mobile device locator service in which the software on a cell phone 127, or other type of mobile device, may operate to send its geographical location information to location-based services application development software platform 101 at a configurable interval, for example, without limitation, every 5-30 seconds. The geographical location data for cell phone 127 may be stored in private central location database 109 in a proprietary and secure fashion. The location of cell phone 127 may be viewed via a map on a secure website. In order to view the secure website, the user may be required to enter a username and password. Furthermore, from the secure website, the owner of cell phone 127 may operate to perform various functions on cell phone 127 including, but not limited to, activating a key-lock feature of cell phone 127, activating device-lock, erasing private/personal data, backing up information from the mobile device to the central database, initiate audible alert and/or vibration alert, modify volume and characteristic of audible alert and/or vibration alert, display messages on device, placing a phone call, taking a picture, video or voice recording and emailing it or sending an Multimedia Messaging Service (MMS) message to any email address or phone number of their choice. Alternate embodiments may be implemented without a mobile device locator service. Non-limiting examples of information which may be restored/erased include contacts, music, pictures, video, email, text messages and other personal information. The transmitted command to activate the ring and/or vibrate and/or modify the volume and characteristic of ring and/or vibrate for the mobile device may operate to bypass configuration settings for the mobile device. The capability provided to remotely command the mobile device to activate key-lock, device-lock, back up, ring and/or vibrate, modify volume and characteristic of ring and/or vibrate, display messages and erase/restore information may be communicated to the mobile device via push notification, Short Message Service (SMS) and/or during a scheduled time for mobile device to communicate with server (e.g. mobile devices communicates with server). Display messages can be invoked by push, SMS or a scheduled time where the device checks the server to see if it should display a message. The capability provided to remotely command the mobile device to perform backup, erasure and restoration of information stored on the mobile device may be initiated by a wireless connection. Display messages can be invoked by push, SMS or a scheduled time where the device checks the server to see if it should display a message. A non-limiting example of a wireless connection for initiating backup may be denoted as Bluetooth.

The present embodiment also comprises an individual website 129 that enabling persons to perform location-based services. For example, without limitation, users of individual website 129 may be buyers and sellers of various items. In this example, users may enter information on individual website 129 related to the items they desire to sell or what they desire to purchase, in addition to a distance between buyer and seller threshold. For example, when a buyer and a seller match the criteria for items they are seeking to sell or purchase, in addition to the distance between seller and purchaser less than the threshold, a message related to the merchandise match may be transmitted to the mobile devices for the seller and the buyer. The users may then open a chat or call the other user for potentially making a transaction. Individual website 129 of location-based services application development software platform 101 may operate to integrate and process the location and time for the matching of buyers and sellers for specific products located anywhere in the world. Users of individual website 129 may also provide various other types of location-based services such as, but not limited to, social networking, posting personal ads, selling an automobile, house, or other types of merchandise. This would allow the users to be location and proximity specific. Alternate embodiments may comprise a website enabling users to perform their own location-based services.

In other embodiments, location-based services application development software platform 101 may be integrated with business intelligence solutions, and data quality providers such as, but not limited to, Cognos (IBM), Microstrategy, Information Builders, Business Objects/SAP, Teradata, Informatica, Hyperion/Oracle, SPSS, etc. Furthermore, in other embodiments location-based services application development software platform 101 may be integrated with other data integration/enterprise application integration solution providers such as, but not limited to, BEA/Oracle, Web Methods/Software AG, Websphere/IBM, Teradata, Informatica, Tibco and Information Builders. Integration with other solutions enables location-based services application development software platform 101 to leverage technology that has been developed and perfected rather than building and integrating new applications into system databases. Integration with other solutions enables the system to process customer location information in conjunction with other information related to a customer which may be maintained by third-party entities. Integration of the system with third party entities may operate to create a virtual real-time “golden record” for customers. In a non-limiting example, the system may have access to information related to products a customer has purchased, retail establishments a customer may frequent. Furthermore, the system may operate to provide timely and relevant one-to-one marketing and information based on location. However, in other embodiments new integration of capabilities may be provided by the databases of the system rather than using pre-existing integrated third-party solutions.

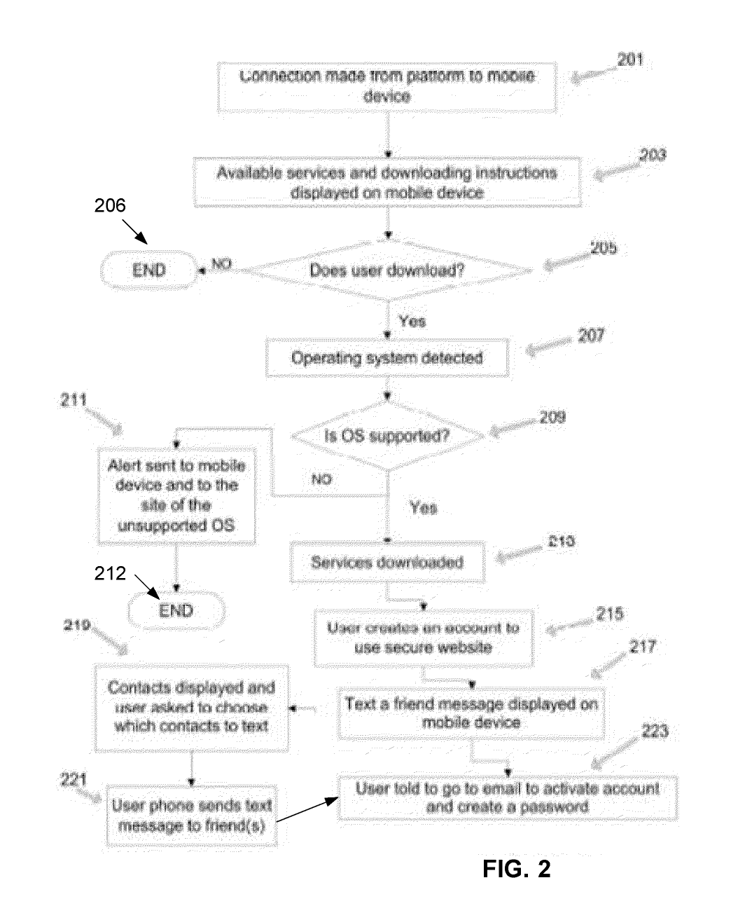

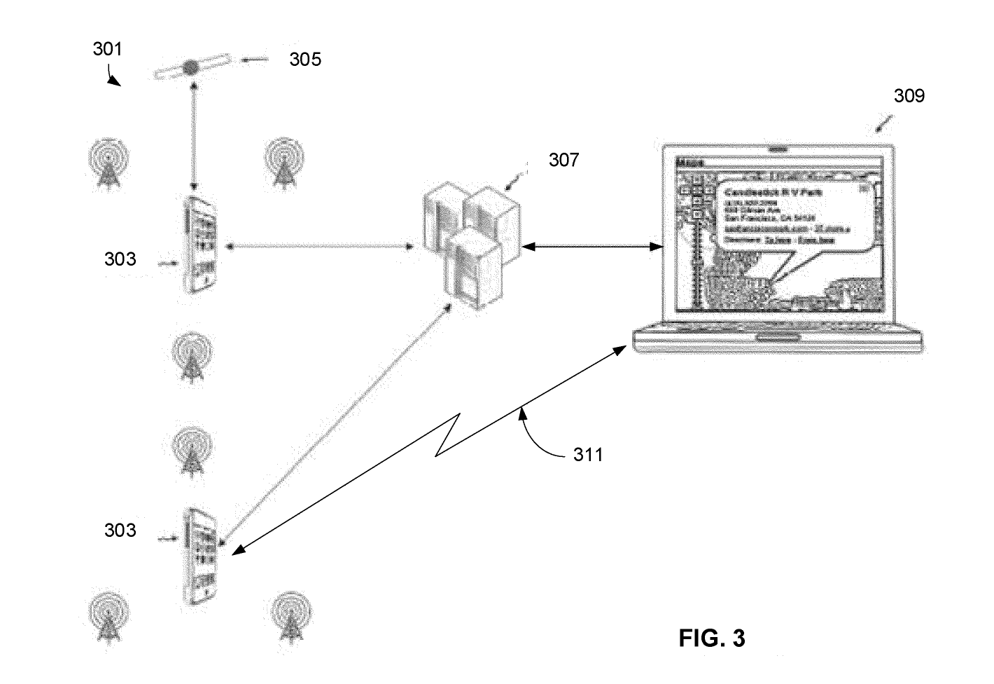

FIG. 2 is a flow chart illustrating an exemplary process for signing up for a location-based service provider, in accordance with an embodiment of the present invention. In the present embodiment, the process begins at a step 201 where a connection may be performed from location-based services application development software platform 101 (FIG. 1) to cell phone 127 (FIG. 1) or other type of mobile device, for example, without limitation, an over the air (OTA), universal serial bus (USB), Bluetooth or infrared (IR) connection. In a non-limiting example, a user may operate to install the software from a mobile device via Bluetooth. For example, for software installed on a mobile device of a friend, acquaintance, associate or contact, the user may operate to connect to the phone of the acquaintance and receive the software for installation or initiate the installation process from his friend's phone via the Bluetooth connection. Through this connection the services available to the user via location-based services application development software platform 101 (FIG. 1) and instructions on how to download the services may be displayed on the display of the cell phone 127 (FIG. 1) or other type of mobile device in a step 203. The process may then determine if the user chooses to download the services in a step 205. For a determination of a user not seeking to download the services, the process may terminate in a step 206. For a determination of user seeking to download the services, the location-based services application development software platform 101 (FIG. 1) may operate to auto-detect the operating system (OS) residing on cell phone 127 (FIG. 1) or other type of mobile device in a step 207. In a step 209 the location-based services application development software platform 101 (FIG. 1) may operate to determine if the OS of cell phone 127 (FIG. 1) or other type of mobile device may be supported. For a determination of the OS not being supported, a message may be transmitted to cell phone 127 (FIG. 1) or other type of mobile device and also to the site of the unsupported OS for administrative tracking in a step 211, followed by the process terminating in a step 212. A non-limiting exemplary message that may be sent to the mobile device is “We are sorry but your device is not currently supported. A message has been sent to the developers, and we will work to make this service available.” For a determination of the OS being supported in step 209, the service may be downloaded in a step 213.

Following application download, user may enter an email address via individual website 129 (FIG. 1) for creating an account in order to access the secure website connected to the location-based services application development software platform 101 (FIG. 1) in a step 215. Then, in a step 217, a text-a-friend message may be displayed on cell phone 127 (FIG. 1) or other type of mobile device requesting whether user desires to text information to his friends related to the service. In the present embodiment, the text-a-friend feature may be provided with the service via the initial download of the software in step 213; however, other embodiments may not provide a text-a-friend feature in the initial software download. For a user choosing to text his friends in step 217, the software operating within cell phone 127 (FIG. 1) or other type of mobile device may operate in a step 219 to automatically extract the list of the contacts stored within the mobile device and request user to choose which contacts he/she desires to transmit a text message, request user to choose which contacts he/she desires to not transmit a text message or choose to allow the software to transmit a text message to every contact included in list of contacts. The text message may be transmitted from the user's phone in a direct fashion in a step 221. The user may be provided an incentive to transmit a text message to acquaintances containing information related to the service to. A non-limiting example of an incentive includes an opportunity to win a new cell phone. In other embodiments the mobile device software may automatically request the user, at a specified interval, for example, without limitation, every 6 weeks, if the user desires to transmit a text message containing information related to the service to his acquaintances. In other embodiments, the user may be requested in a single instance if user desires to text his acquaintances. In the present embodiment, following the transmission of contact information in step 221 or if the user chooses not to text his friends in step 217, a message may be transmitted to the mobile device instructing the user to access his email capability in a step 223 in order to activate his account and create a password. After successful completion of step 223, the user may operate to access the services offered by the location-based services application development software platform 101 (FIG. 1).

Those skilled in the art, in light of the present teachings, will readily recognize that the steps described in the previous process may be performed in a different order and in some cases steps may be omitted or added. For example, without limitation, some embodiments may not implement a text-a friend-sequence. Also, the user may be asked to create a password at the same time that the account is created rather than later in the process. In other embodiments, the software can be installed such that location data may be transmitted to the server, and the user may operate to interact with the system without supplying a username and password or creating an account for the web site.

FIG. 3 illustrates an exemplary location-based mobile device locator system 301, in accordance with an embodiment of the present invention. Users of the system may be provided a tremendous convenience for locating and recovering their mobile devices, including information associated with the mobile device such as contacts, pictures, calendars and other information, in a quick and easy manner. In the present embodiment, a mobile device 303 may be located using a GPS 305 since, in the U.S., every cell phone produced after 2006 is required to be GPS enabled. Location information for mobile device 303 may be determined via GPS 305. Location information for mobile device may also be determined via cell phone tower triangulation. Software executing on mobile device 303 may transmit its location information to a datacenter 307 at a configurable time interval. In some embodiments, the software executing on the mobile device 303 may operate to not transmit location information to the server if the location of mobile device 303 has not changed since the previous transmission of location information. Furthermore, following a change of location for mobile device 303, the software may operate to transmit location information for mobile device 303 at a predetermined rate. Mobile device 303 operating to not transmit location information when there has not been a change in location generally reduces bandwidth, and server and database processing. In the present embodiment, mobile device 303 may operate to transmit tracking information every 5-30 seconds; however, differing intervals may be used for other embodiments. In the present embodiment, the software executing on mobile device 303 to sends location data to datacenter 307 executes in the background of the operating system for mobile device 303. Furthermore, location data may be continuously transmitted by mobile device 303 to datacenter 307 even for the application located on mobile device 303 being configured in a non-operational mode.

Datacenter 307 comprises servers and databases, and the location data for mobile device 303 may be stored in a central database located in datacenter 307 and may be stored in a proprietary and secure fashion. Datacenter 307 may be integrated with a third party mapping service such as, but not limited to, Google Maps, MSFT Maps, Navteq or Telenav such that that the location of mobile device 303 may be viewed via a map displayed on a secure website 309. Secure website 309 may operate to communication bi-directionally with mobile device 303 via an over-the-air wireless communication channel 311. In order to access secure website 309, the user may be required to enter a username and a password. The user may perform various functions on secure website 309 including, without limitation, creating, editing or suspending a profile, locating a mobile device, paying for services, accessing functions on the mobile device, etc. In some embodiments of the present invention, the consumer may be provided with a remote access capability to activate the key-lock feature on the phone from the web site, activate device-lock, back up data (e.g., automatically, by user or from the web site), initiate ring and/or vibrate, modify volume and characteristic of ring and/or vibrate, display messages on device and erase/restore information on the phone. Non-limiting examples of information which may be restored/erased include contacts, music, pictures, video, email, text messages and other personal information. The transmitted command to activate the ring and/or vibrate and/or modify the volume and characteristic of ring and/or vibrate for the mobile device may operate to bypass configuration settings for the mobile device. The capability provided to remotely command the mobile device to activate key-lock, device-lock, back up, ring and/or vibrate, modify volume and characteristic of ring and/or vibrate, display messages and erase/restore information may be communicated to the mobile device via push notification, SMS and/or during a scheduled time for mobile device to communicate with server (e.g. mobile devices communicates with server). Display messages can be invoked by push, SMS or a scheduled time where the device checks the server to see if it should display a message. The capability provided to remotely command the mobile device to perform backup, erasure and restoration of information stored on the mobile device may be initiated by a wireless connection. A non-limiting example of a wireless connection for initiating backup may be denoted as Bluetooth. Display messages can be invoked by push, SMS or a scheduled time where the device checks the server to see if it should display a message

In typical application of the present embodiment when a user thinks they have lost or had their mobile device 303 stolen, the user may log onto secure website 309 using a unique password in order to view the location of mobile device 303. Furthermore, mobile device 303 may be displayed on a map similar to a map as displayed on MapQuest. For the situation where mobile device 303 has been stolen and the Subscriber Identity Module (SIM) card replaced, the phone number of the new SIM card may be displayed on secure website 309. The owner of mobile device 303 may then be in possession for the phone number of the thief and may report this information to the police. For a situation where the battery of mobile device 303 ceases to operate or where tampering has been performed on the operating system or firmware of mobile device 303, the software of mobile device 303 may operate to transmit its current location to datacenter 307. In the present embodiment, the owner may also activate a key-lock feature on mobile device 303, activate device-lock erase private or personal data, initiate ring and/or vibrate, modify volume and characteristic of ring and/or vibrate, display messages on device, place a phone call, take a picture, video or voice recording and email or MMS message this information to any email address or phone number from secure website 309. Non-limiting examples of information which may be restored/erased include contacts, music, pictures, video, email, text messages and other personal information. The transmitted command to activate the ring and/or vibrate and/or modify the volume and characteristic of ring and/or vibrate for the mobile device may operate to bypass configuration settings for the mobile device. The capability provided to remotely command the mobile device to activate key-lock, device-lock, back up, ring and/or vibrate, modify volume and characteristic of ring and/or vibrate, display messages and erase/restore information may be communicated to the mobile device via push notification, SMS and/or during a scheduled time for mobile device to communicate with server (e.g. mobile devices communicates with server). Display messages can be invoked by push, SMS or a scheduled time where the device checks the server to see if it should display a message. The capability provided to remotely command the mobile device to perform backup, erasure and restoration of information stored on the mobile device may be initiated by a wireless connection. Display messages can be invoked by push, SMS or a scheduled time where the device checks the server to see if it should display a message. A non-limiting example of a wireless connection for initiating backup may be denoted as Bluetooth. Other embodiments may be implemented for tracking mobile devices without providing capabilities for enabling a user to access control features of the mobile device.

In order to offer privacy to users, secure website 309 and datacenter 307 in the present embodiment may be located in a secured environment where the true owner of mobile device 303 may be given access for viewing the location of mobile device 303. An operation to view the location of mobile device 303 on secure website 309 may initiate transmission of an email and a text message to user. Transmission of text message notice may be delayed, for example, without limitation, 36 hours later. Capabilities may be provided for a user to change their password, for example in a case of unauthorized use. Furthermore, a listing of the last ten location views of mobile device 303 may be displayed on secure website 309 so user may be notified of unauthorized access for viewing the location of a mobile device.

Mobile device locator systems, according to aspects of the present invention, may operate to lower telecommunications costs for consumers and increase consumer's level of satisfaction and retention with carriers by aiding consumers in locating lost or stolen mobile devices. Mobile device locator systems may also operate as a source for revenue generation and cost savings for insurers and carriers. The present embodiment primarily targets users with higher-end cell phones or smartphones and personal digital assistants (PDAs), as these users may be concerned with the financial loss of a mobile device and also with the loss of personal information. However, the present embodiment may not be limited to higher-end mobile devices, but may be accessed for any variety of mobile devices.

Similar to the mobile device locator service described by way of example in accordance with FIG. 3, some embodiments of the present invention may also include a friend and family locator service. Users of this service may view the geographical locations of their friends and family members on a website or on a display of a map on their mobile device. In the present embodiment, this service may be configured for activation or non-activation. Furthermore, user may operate to select which friends or family members may or may not operate to view user's location information. The user may also configure the software to transmit an alert to their mobile device when mobile device determines a friend or family member may be located within a certain distance or range from user. This distance or range may be configured via the website or via the user's mobile device. In other embodiments, users may also operate to:

1. view friends location via the web site or via the handset of the mobile device;
2. configure acquaintances which may operate to view user's location;
3. share photos tagged to a location;
4. recommend places, etc. to acquaintances;
5. share associated location information; and
6. view journals of acquaintances and post comments.

In the present embodiment, following software installation and account activation, the location information for mobile device configured for or associated with the service may be transmitted to a server and central database for storage, similarly to the datacenter as described by way of example in accordance with FIG. 3. The software operating to transmit location information to the server and central database executes in the background on the mobile device even if service has been configured for non-operation. In the present embodiment, even though a user may inactivate the service or block certain friends and family members from access to a information associated with the mobile device, the mobile device may operate to continue transmitting the associated location information for the mobile device to the server and central database. Also, this system may operate to execute in the background of the mobile device in an undetected fashion and may not require an application to be activated on the mobile device in order to transmit location information. Furthermore, the service in the present embodiment may operate to transmit location information to the server and central database every 5-30 seconds. Furthermore, the service may operate to store historical data in the central database to be retrieved later for processing by location-based services as described by way of example in accordance with FIG. 1. In order to alleviate bandwidth and server and database loading, the mobile device software for the present embodiment may operate to transmit location information following a modification in the mobile devices location. In other embodiments, the mobile device may transmit location information to the server and central database at differing intervals to time.

A friend and family locator service according to the present embodiment may be integrated with dating sites such as, but not limited to, match.com, social networking sites such as, but not limited to, myspace.com and facebook.com or a standalone system. In the standalone system, the family and friend locator service may be used and administered via the mobile device or via the website of the lost/phone locator embodiment. Users of a friend and family locator service integrated with a social networking system or a standalone system may operate to perform various functions such as, but not limited to, commenting on or posting pictures and videos on certain locations to leave for friends or family members, meeting people with similar interests in nearby locations, etc.

In some embodiments of the friend and family locator a business mode may be provided whereby the family and friend locator may operate to allow the user to activate or inactivate personal and/or business mode. For activated business mode, a user may operate to determine whether a business associate or other person of interest may be located nearby.

In other embodiments, the mobile device software may be installed and executed on handheld gaming systems in order to provide location dependent games. For example, users of the mobile device or handheld gaming system may operate to engage in entertainment applications such as, but not limited to, games adapted to a geographical area and interactive games between other users in proximity to the user.

In other embodiments of the present invention, a location based emergency service may be provided where a user may operate to push a panic/emergency button and the system server searches for other users located nearby that may be in position to aid user. In some related embodiments, a “health emergency” button may be provided prompting the server to search for other users, such as health care professionals, located near the user and send an alert to the health care professionals (or other emergency service providers) and instruct them on how find (e.g., walked to) the user in need of medical aid. Furthermore, location-based emergency services may be provided on an opt-in basis, for example as a Good Samaritan offering.

In other embodiments, an alert may be communicated from the mobile device to the server when the original SIM card device located within the mobile device has been exchanged for a different SIM card. A non-limiting example of information which may be included in the alert includes the phone number associated with the newly inserted SIM card.

In other embodiments, a message may be communicated by user to acquaintances, contacts and associates with information related to the location of the mobile device. Furthermore, server may operate to receive and process location information from the mobile devices of acquaintances, contacts and associates of user. Furthermore, a message may be communicated by user to acquaintances, contacts and associates which may be in close proximity to the mobile device.

In other embodiments, server may operate to receive and process location information from the mobile devices of acquaintances, contacts and associates of user. Furthermore, user may be notified via mobile device when the mobile devices of acquaintances, contacts and associates of user may be in close proximity to user's mobile device. Furthermore, user may operate to communicate the location of user to the mobile devices of acquaintances, contacts and associates of user. Furthermore, user may operate to communicate the location of the mobile devices of acquaintances, contacts and associates to other entities.

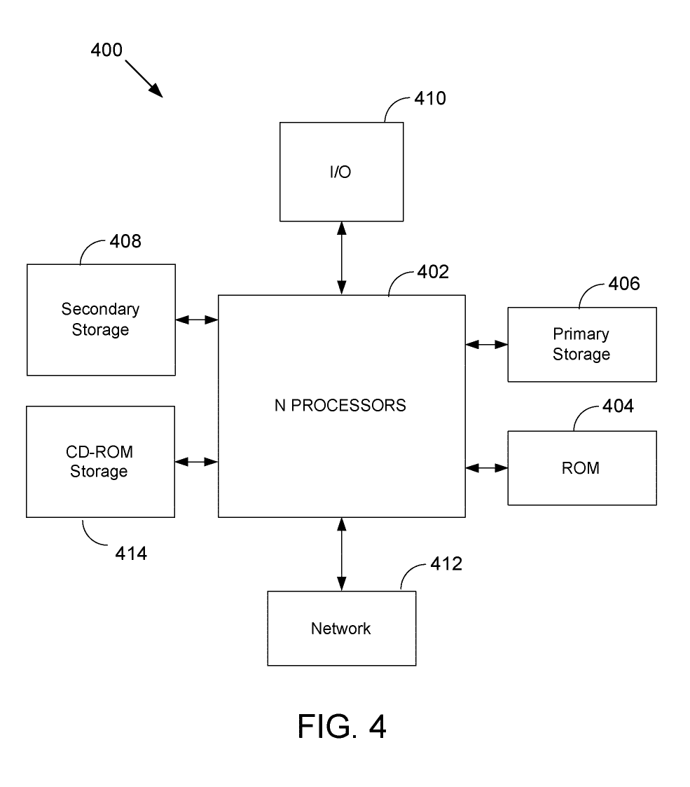

FIG. 4 illustrates a typical computer system that, when appropriately configured or designed, can serve as a computer system 400 in which exemplary embodiments of the present invention may be embodied. The computer system 400 includes any number of processors 402 (also referred to as central processing units, or CPUs) that are coupled to storage devices including a primary storage 406 (typically a random access memory, or RAM), a primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and non-programmable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally as a network 412, which may be implemented as a hardwired or wireless communications link using suitable conventional technologies. With such a connection, CPU may operate to receive information from the network, or transmit information to the network in the course of performing the method steps described in the teachings of the present invention.

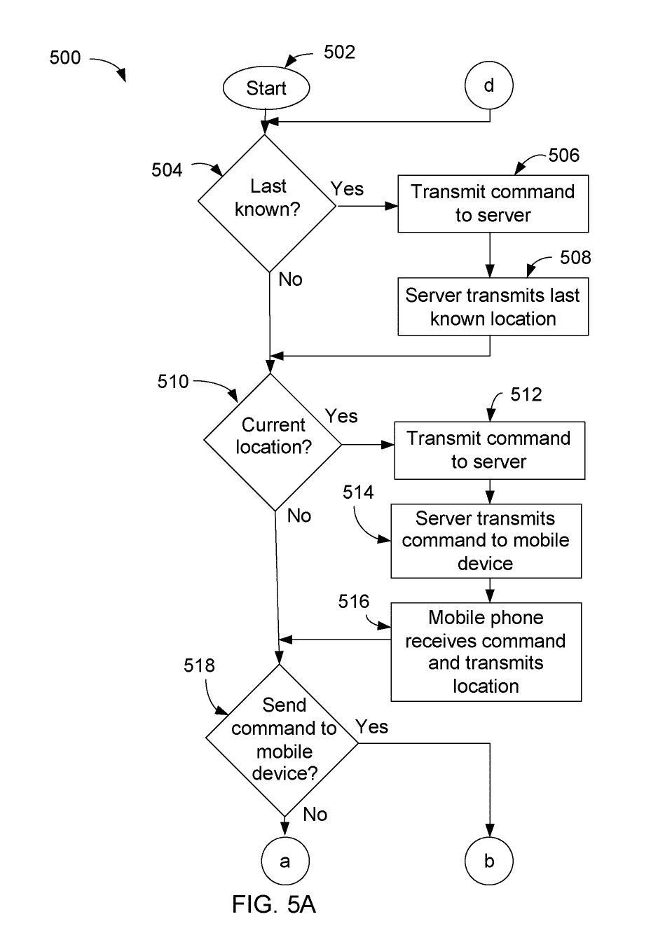

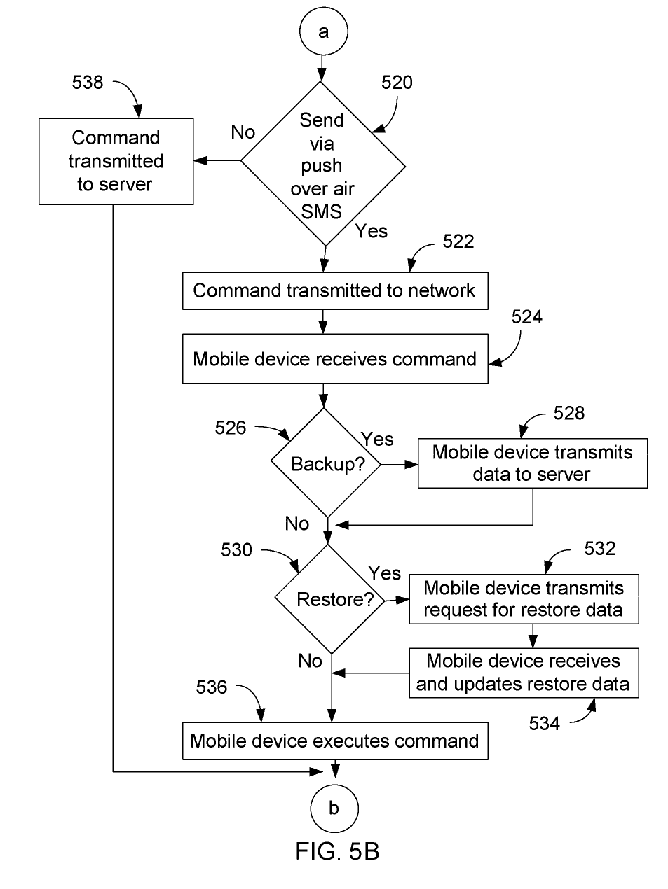

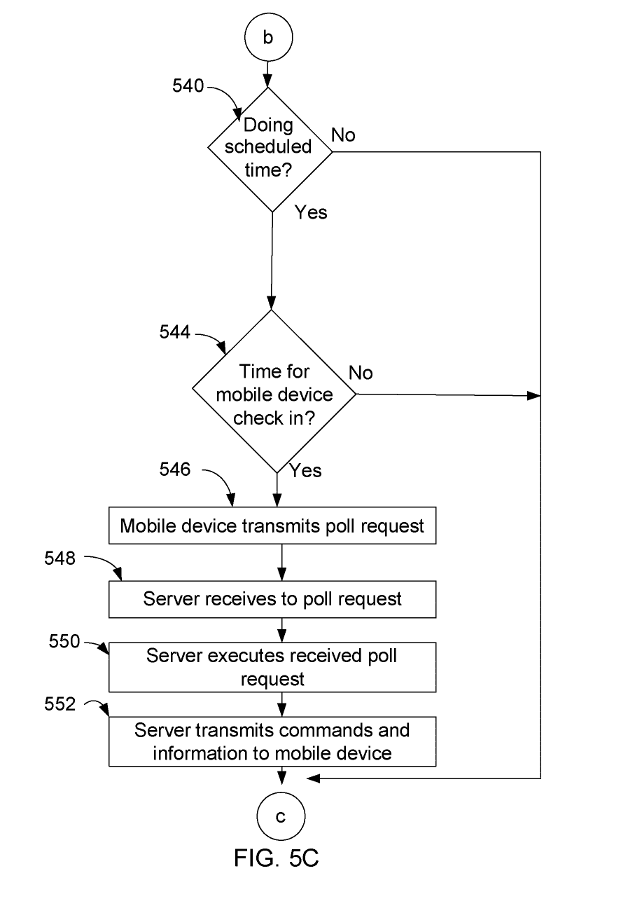

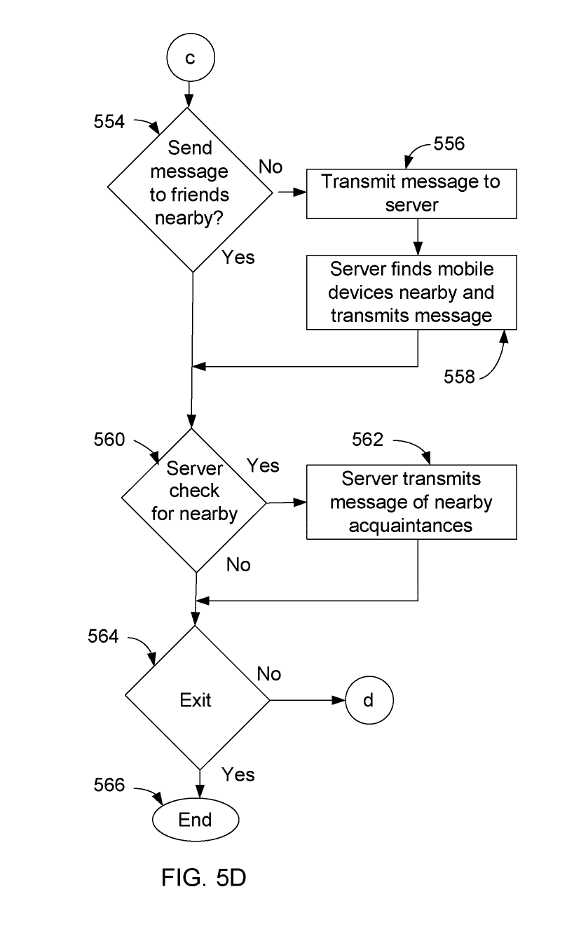

FIGS. 5A-D present a flow chart illustrating an exemplary method 500 for interaction with the elements of location-based mobile device locator system 301 (FIG. 3), in accordance with an alternative embodiment of the present invention.

For the present exemplary embodiment, the process initiates in a step 502 (FIG. 5A). In a step 504, it may be determined whether user seeks to determine the last known location for mobile device 303 (FIG. 3). For a determination of user seeking to ascertain the last known location of mobile device 303 (FIG. 3) in step 504, user may operate to transmit a command from secure website 309 (FIG. 3) to datacenter 307 (FIG. 3) in a step 506 indicating user seeks last known location for mobile device 303 (FIG. 3). In a step 508, datacenter 307 (FIG. 3) may determine the last known location for mobile device 303 (FIG. 3) and transmit last known information for mobile device 303 (FIG. 3) to user via secure website 309 (FIG. 3).

In a step 510, it may be determined whether user seeks to determine the current location for mobile device 303 (FIG. 3). For a determination of user seeking to ascertain the current location of mobile device 303 (FIG. 3) in step 510, user may operate to transmit a command from secure website 309 (FIG. 3) to datacenter 307 (FIG. 3) in a step 512 indicating user seeks current location for mobile device 303 (FIG. 3). In a step 514, datacenter 307 (FIG. 3) may operate to transmit a command to mobile device 303 (FIG. 3) requesting current location. In a step 516, mobile device 303 (FIG. 3) receives request for current location and transmits current location to user via datacenter 307 (FIG. 3) and secure website 309 (FIG. 3).

In a step 518, it may be determined whether user seeks to transmit a command to mobile device 303 (FIG. 3). Non-limiting examples of commands include delete stored information, initiate/terminate audible alert, initiate/terminate vibration alert, modify volume and characteristic of audible alert, modify characteristic of vibration alert, transmit text message, transmit email, display message backup information and restore information. For a determination of user seeking to transmit a command to mobile device 303 (FIG. 3) in step 518, it may be determined in a step 520 (FIB. 5B) whether user seeks to transmit command via push notification, over-the-air or SMS. For a determination of user seeking to transmit command via push notification, over-the-air or SMS in step 520, command may be transmitted in a step 522 to the respective push notification, over-the-air or SMS network for transmission to mobile device 303 (FIG. 3). In a step 524, mobile device 303 (FIG. 3) may operate to receive command.

In a step 526, it may be determined whether the command received by mobile device 303 (FIG. 3) requests mobile device 303 (FIG. 3) to perform backup. For a determination of a request for mobile device 303 (FIG. 3) to perform a backup in step 526, mobile device 303 (FIG. 3) may operate to transmit data and information for backup to datacenter 307 (FIG. 3) in a step 528.

In step 526, it may be determined whether the command received by mobile device 303 (FIG. 3) requests mobile device 303 (FIG. 3) to perform a restoration of data information. For a determination of a request for mobile device 303 (FIG. 3) to perform restoration of data and information in a step 530, mobile device transmits request to restore data to datacenter 307 (FIG. 3) in a step 532. In a step 534, mobile device receives data and information transmitted by datacenter 307 (FIG. 3) and performs a restoration of the received data and information to mobile device 303 (FIG. 3). In a step 536, mobile device 303 (FIG. 3) may operate to execute received commands, other than commands for backup and restoration which may have already been executed in previous steps.

For a determination of user not seeking to send a command via push notification, over-the-air or SMS in step 520, in a step 538, user command may be transmitted to datacenter 307 (FIG. 3).

Following user command transmission to datacenter 307 (FIG. 3) of step 538 and mobile device 303 (FIG. 3) executing command in step 536, it may be determined in a step 540 (FIG. 5C) whether mobile device 303 (FIG. 3) may be configured for performing scheduled communication exchanges with datacenter 307 (FIG. 3). For a determination of performing scheduled communication exchanges in step 540, it may be determined in a step 544 whether the timing may be appropriate for mobile device 303 (FIG. 3) to query datacenter 307 (FIG. 3) for exchange of information. For a determination of appropriate timing for mobile device 303 (FIG. 3) to query datacenter 307 (FIG. 3) in a step 544, mobile device 303 (FIG. 3) may operate in a step 546 to transmit a query command to datacenter 307 (FIG. 3). In a step 548, datacenter 307 (FIG. 3) may receive query command. In a step 550, datacenter 307 (FIG. 3) may operate to execute the received query command. In a step 552, datacenter 307 (FIG. 3) may operate to transmit command and information to mobile device 303 (FIG. 3).

For a determination of not performing scheduled communication exchange in step 540, not appropriate timing for mobile device 303 (FIG. 3) to query datacenter 307 (FIG. 3) in step 544 and following server transmitting commands and information to mobile device 303 (FIG. 3) in step 552, it may be determined in a step 554 (FIG. 5D) whether user seeks to send messages to nearby acquaintances. For a determination of user seeking to send messages to nearby acquaintances in step 554, user may operate to transmit a message for nearby acquaintance delivery in a step 556 to datacenter 307 (FIG. 3) via mobile device 303 (FIG. 3) or via secure website 309 (FIG. 3). In a step 558, datacenter 307 (FIG. 3) may operate to determine acquaintances nearby to mobile device 303 (FIG. 3) and transmit message to nearby acquaintances.

It may be determined in a step 560 (FIG. 3) whether user seeks to be notified of nearby acquaintances. For a determination of user seeking to be notified of nearby acquaintances in step 560 (FIG. 3), datacenter 307 (FIG. 3) may in a step 562 operate to receive, process and transmit location of nearby acquaintances to mobile device 303 (FIG. 3).

It may be determined in a step 564 whether method 500 may operate to terminate execution. For a determination of not terminating execution of method 500 in step 564, operation of method 500 transfers to step 504 (FIG. 5A). For a determination of terminating execution of method 500 in step 564, method terminates execution in a step 566.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the databases and location based services may be performed and/or located outside of the jurisdiction of the USA while the remaining method steps and/or system components of the forgoing embodiments are typically required to be located/performed in the US for practical considerations.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing location-based services as mobile applications according to the present invention will be apparent to those skilled in the art. The invention has been described above by way of illustration, and the specific embodiments disclosed are not intended to limit the invention to the particular forms disclosed. For example, the particular implementation of the location-based services may vary depending upon the particular type of device used. The devices described in the foregoing were directed to cell phone and PDA implementations; however, similar techniques are to provide location-based services to other types of devices such as, but not limited to, automobiles, notebook computers, handheld electronic games, navigation systems, desktop computers, etc. Implementations of the present invention made for devices other than cell phones and PDAs are contemplated as within the scope of the present invention. The invention is thus to cover all modifications, equivalents, and alternatives falling within the spirit and scope of the following claims.

What is claimed is:

1. A system for a mobile communication device, the system comprising:
a software module configured for executing in a background mode in a processor of the mobile communication device, said software module being operable to communicate a geographical location of the mobile communication device at a scheduled time and to receive at least one command to execute an operation of the mobile communication device;
a datacenter operable to receive said geographical location and to transmit said at least one command; and
a secure website, in communication with said datacenter, where a user can request a display of said geographical location and select said at least one command to be transmitted.

2. The system as recited in claim 1, in which the user can further select a time to transmit said at least one command.

3. The system as recited in claim 2, in which time selections for transmitting said at least one command comprises immediate and said scheduled time.

4. The system as recited in claim 1, in which command selections include a ring command where execution of said ring command sets the mobile communication device to ring at an audible level and the mobile communication device is operated to ring.

5. The system as recited in claim 1, in which command selections include a message command where execution of said message command displays a text message on the mobile communication device.

6. The system as recited in claim 1, in which selecting said message command further transmits a message to at least one additional mobile communication device.

7. The system as recited in claim 1, in which command selections include a backup command where execution of said backup command communicates stored information from the mobile communication device to said datacenter.

8. The system as recited in claim 1, in which command selections include a restore command where execution of said restore command retrieves stored information from said datacenter.

9. The system as recited in claim 1, in which command selections include a delete command where execution of said delete command deletes stored information from the mobile communication device.

10. The system as recited in claim 1, in which command selections include a lock command where execution of said lock command prevents use of the mobile communication device.

11. A method comprising:
connecting to a datacenter using a secure website;
sending a request to said datacenter for a geographical location of a mobile communication device;
receiving a last known location of said mobile communication device from said datacenter where said datacenter communicates with a software module configured for executing in a background mode in a processor of said mobile communication device, said software module being operable to communicate said geographical location at a scheduled time and to receive at least one command to execute an operation of the mobile communication device;
selecting said at least one command;
sending said selected at least one command to said datacenter for transmission to said software module;
selecting a time for said transmission to said software module where time selections comprise immediate and said scheduled time; and
sending said selected time to said datacenter where said selected at least one command is transmitted to said software module at said selected time for execution.

12. The method as recited in claim 11, in which command selections include a ring command where execution of said ring command sets the mobile communication device to ring at an audible level and the mobile communication device is operated to ring.

13. The method as recited in claim 11, in which command selections include a message command where execution of said message command displays a text message on the mobile communication device.

14. The method as recited in claim 11, in which selecting said message command further transmits a message to at least one additional mobile communication device.

15. The method as recited in claim 11, in which command selections include a backup command where execution of said backup command communicates stored information from the mobile communication device to said datacenter.

16. The method as recited in claim 11, in which command selections include a restore command where execution of said restore command retrieves stored information from said datacenter.

17. The method as recited in claim 11, in which command selections include a delete command where execution of said delete command deletes stored information from the mobile communication device.

18. The method as recited in claim 11, in which command selections include a lock command where execution of said lock command prevents use of the mobile communication device.

19. A computer program product residing on or being distributed across one or more computer readable mediums having a plurality of instructions stored thereon which, when executed by one or more associated processors, cause the one or more processors to:
connect to a datacenter using a secure website;
send a request to said datacenter for a geographical location of a mobile communication device;
receive a last known location of said mobile communication device from said datacenter where said datacenter communicates with a software module configured for processing in a background mode in a processor of said mobile communication device, said software module being operable to communicate said geographical location at a scheduled time and to receive at least one command to execute an operation of the mobile communication device;
select said at least one command;
send said selected at least one command to said datacenter for transmission to said software module;
select a time for said transmission to said software module where time selections comprise immediate and said scheduled time; and
send said selected time to said datacenter where said selected at least one command is transmitted to said software module at said selected time for execution.

20. The computer program product as recited in claim 19, in which command selections include ring command, message command, backup command, restore command, delete command, and lock command.
